(19) United States
(12) Patent Application Publication
(10) Pub. No.: US 2026/0241713 A1
(43) Pub. Date: Aug. 20, 2026

(54) PRINTING APPARATUS

(71) Applicant: SEIKO EPSON CORPORATION, TOKYO (JP)

(72) Inventors: Yuichi WASHIO, SHIOJIRI-SHI (JP); Reo SUZUKI, MATSUMOTO-SHI (JP)

(21) Appl. No.: 19/545,335

(22) Filed: Feb. 20, 2026

(30) Foreign Application Priority Data
Feb. 20, 2025 (JP) 2025-026045

(51) Int. Cl. B41J 11/00; B41J 29/00

(52) U.S. Cl. CPC B41J 11/0024; B41J 29/00

(57) ABSTRACT

A printing apparatus includes a transport section that transports a medium in a transport direction, a printing section that performs printing by discharging a liquid to the transported medium, and a drying section that dries the medium after the printing. The drying section includes a contact heating plate that comes into contact with a back surface of the medium after the printing on a first surface, a heating portion that heats the contact heating plate from a second surface side, and a heating plate holding portion to which the contact heating plate is attached. A reinforcing member extending in a width direction is fixed to each of an upstream end portion and a downstream end portion in the transport direction, on a second surface of the contact heating plate.

The present application is based on, and claims priority from JP Application Serial Number 2025-026045, filed February 20, 2025, the disclosure of which is hereby incorporated by reference herein in its entirety.

### BACKGROUND

### 1. Technical Field

The present disclosure relates to a printing apparatus.

### 2. Related Art

Various printing apparatuses have been used in the related art. In the printing apparatuses, there is a printing apparatus including a contact heating plate that brings a heating portion into contact with a back surface of a medium which is opposite to a printing surface of the medium in a drying section in order to dry a liquid discharged to the medium. For example, JP-A-2023-133808 discloses a printing apparatus including a first heater and a second heater which are brought into contact with a back surface of a medium to heat the medium inside a drying section.

In a printing apparatus including a contact heating plate that brings a heating portion into contact with a back surface of a medium which is opposite to a printing surface of the medium in a drying section, in some cases, the contact heating plate may be deformed due to heat, for example. When the contact heating plate is deformed, a transport load increases, and transport accuracy of the medium is lowered, thereby causing a possibility that printing quality is lowered.

### SUMMARY

According to an aspect of the present disclosure, there is provided a printing apparatus including a transport section that transports a medium in a transport direction, a printing section that performs printing by discharging a liquid to the medium transported by the transport section, and a drying section that dries the medium after the printing is performed by the printing section. The drying section includes a contact heating plate that comes into contact with a back surface of the medium, which is a surface opposite to a printing surface of the medium after the printing, on a first surface, a heating portion that heats the contact heating plate, and a heating plate holding portion to which the contact heating plate is attached. A reinforcing member extending in a width direction intersecting the transport direction is fixed to each of an upstream end portion and a downstream end portion in the transport direction, on a second surface of the contact heating plate on a side opposite to the first surface.

### BRIEF DESCRIPTION OF THE DRAWINGS

FIG. 1 is a side view of a printing apparatus according to Example 1 of the present disclosure.

FIG. 2 is a side view illustrating a periphery of a drying section of the printing apparatus in FIG. 1.

FIG. 3 is a perspective view illustrating a part of the drying section of the printing apparatus in FIG. 1.

FIG. 4 is a conceptual diagram illustrating a state of a medium transported in the drying section of the printing apparatus in FIG. 1.

FIG. 5 is a perspective view illustrating a part of the drying section of the printing apparatus in FIG. 1 when viewed from an angle different from that in FIG. 3.

FIG. 6 is an enlarged perspective sectional view illustrating an attachment portion of the contact heating plate to a heating plate holding portion of the drying section of the printing apparatus in FIG. 1.

FIG. 7 is an enlarged perspective view illustrating an attachment portion of the contact heating plate to the heating plate holding portion of the drying section of the printing apparatus in FIG. 1.

FIG. 8 is a perspective view illustrating a part of the drying section of the printing apparatus in FIG. 1 when viewed from an angle different from those in FIGS. 3 and 5, and is a view illustrating an upstream end portion of the contact heating plate.

FIG. 9 is a perspective view when a periphery of a reinforcing member of the drying section of the printing apparatus in FIG. 1 is viewed from a second surface side, and is a view illustrating the upstream end portion or a downstream end portion of the contact heating plate.

FIG. 10 is a perspective view when a periphery of the reinforcing member of the drying section of the printing apparatus in FIG. 1 is viewed from a first surface side, and is a view illustrating the upstream end portion or the downstream end portion of the contact heating plate.

FIG. 11 is a perspective view illustrating the reinforcing member of the drying section of the printing apparatus in FIG. 1.

FIG. 12 is a schematic cross-sectional view illustrating an attachment state of the contact heating plate and the reinforcing member of the drying section of the printing apparatus in FIG. 1.

FIG. 13 is a perspective view illustrating a part of a drying section of a printing apparatus according to a reference example.

FIG. 14 is a conceptual diagram illustrating a state of a medium transported in the drying section of the printing apparatus in FIG. 13.

FIG. 15 is a conceptual diagram illustrating a contact heating plate of the drying section of the printing apparatus in FIG. 13.

### DESCRIPTION OF EMBODIMENTS

First, the present disclosure will be briefly described.

According to a first aspect of the present disclosure, there is provided a printing apparatus including a transport section that transports a medium in a transport direction, a printing section that performs printing by discharging a liquid to the medium transported by the transport section, and a drying section that dries the medium after the printing is performed by the printing section. The drying section includes a contact heating plate that comes into contact with a back surface of the medium, which is a surface opposite to a printing surface of the medium after the printing, on a first surface, a heating portion that heats the contact heating plate, and a heating plate holding portion to which the contact heating plate is attached. A reinforcing member extending in a width direction intersecting the transport direction is fixed to each of an upstream end portion and a downstream end portion in the transport direction, on a second surface of the contact heating plate on a side opposite to the first surface.

According to the present aspect, the reinforcing member extending in the width direction intersecting the transport direction is fixed to each of the upstream end portion and the downstream end portion in the transport direction, on the second surface of the contact heating plate. According to this configuration, deformation of the contact heating plate can be suppressed. Therefore, an increase in a transport load which is caused by deformation of the contact heating plate can be suppressed.

As the printing apparatus according to a second aspect of the present disclosure, in the aspect dependent on the first aspect, the reinforcing member may be fixed only to the second surface without coming into contact with the heating plate holding portion.

According to the present aspect, the reinforcing member is fixed only to the second surface, and is not fixed to a surface other than the second surface. According to this configuration, a force applied to the reinforcing member via the contact heating plate can be prevented from directly affecting a member other than the reinforcing member.

As the printing apparatus according to a third aspect of the present disclosure, in the aspect dependent on the first or second aspect, a surface of the reinforcing member on a side attached to the contact heating plate may be a concave surface.

According to the present aspect, the surface of the reinforcing member on the side attached to the heating plate is the concave surface. According to this configuration, friction between the transported medium and the first surface can be reduced, and the increase in the transport load can be effectively suppressed.

As the printing apparatus according to a fourth aspect of the present disclosure, in the aspect depending on any one of the first to third aspects, the contact heating plate may be provided with a plurality of first through-holes aligned along the transport direction at both end portions in the width direction, may be fastened via a screw to the heating plate holding portion at positions of the plurality of first through-holes, and may be movable with respect to the heating plate holding portion in a direction intersecting a thickness direction of the contact heating plate in a state where the contact heating plate is fastened via the screw at the positions of the plurality of first through-holes.

According to the present aspect, the contact heating plate is movable with respect to the heating plate holding portion in a direction intersecting a thickness direction of the contact heating plate in a state where the contact heating plate is fastened via a screw at positions of the plurality of first through-holes. According to this configuration, even when the contact heating plate is expanded due to heating, an expansion amount of the contact heating plate can be released in the direction intersecting the thickness direction of the contact heating plate, and the expansion of the contact heating plate in the thickness direction of the contact heating plate can be suppressed. Therefore, the increase in the transport load which is caused by the deformation of the contact heating plate due to heat can be effectively suppressed.

As the printing apparatus according to a fifth aspect of the present disclosure, in the aspect depending on the fourth aspect, the drying section may include a spacer thicker than a depth of the first through-hole.

According to the present aspect, the drying section includes the spacer thicker than the depth of the first through-hole. According to this configuration, even when the contact heating plate is expanded due to heating, the expansion amount of the contact heating plate can be particularly effectively released in the direction intersecting the thickness direction of the contact heating plate, and the expansion of the contact heating plate in the thickness direction of the contact heating plate can be particularly effectively suppressed. Therefore, the increase in the transport load which is caused by the deformation of the contact heating plate due to heat can be particularly effectively suppressed.

As the printing apparatus according to a sixth aspect of the present disclosure, in the aspect depending on the fourth aspect, the screw may be a stepped screw having a stepped portion, and a thickness of the stepped portion may be thicker than a depth of the first through-hole.

According to the present aspect, the screw is the stepped screw having the stepped portion, and the thickness of the stepped portion is thicker than the depth of the first through-hole. According to this configuration, even when the contact heating plate is expanded due to heating, the expansion amount of the contact heating plate can be particularly effectively released in the direction intersecting the thickness direction of the contact heating plate, and the expansion of the contact heating plate in the thickness direction of the contact heating plate can be particularly effectively suppressed. Therefore, the increase in the transport load which is caused by the deformation of the contact heating plate due to heat can be particularly effectively suppressed.

As the printing apparatus according to a seventh aspect of the present disclosure, in the aspect depending on the fourth aspect, a depth of the screw hole fitted to the screw of the heating plate holding portion may be a depth at which a distance between a screw head of the screw and a forming surface of the screw hole is larger than a thickness of the contact heating plate when the contact heating plate is fastened via the screw at the positions of the plurality of first through-holes.

According to the present aspect, the depth of the screw hole of the heating plate holding portion is the depth at which the distance between the screw head and the forming surface of the screw hole is larger than the thickness of the contact heating plate when the contact heating plate is fastened via the screw at the position of the first through-hole. According to this configuration, even when the contact heating plate is expanded due to heating, the expansion amount of the contact heating plate can be particularly effectively released in the direction intersecting the thickness direction of the contact heating plate, and the expansion of the contact heating plate in the thickness direction of the contact heating plate can be particularly effectively suppressed. Therefore, the increase in the transport load which is caused by the deformation of the contact heating plate due to heat can be particularly effectively suppressed.

As the printing apparatus according to an eighth aspect of the present disclosure, in the aspect depending on any one of the fourth to seventh aspects, the first through-hole may have a width having a distance from a screw shaft of the screw.

According to the present aspect, the first through-hole has the width having the distance from the screw shaft of the screw. According to this configuration, a configuration can be easily formed in which the contact heating plate is movable with respect to the heating plate holding portion in the direction intersecting the thickness direction of the contact heating plate in a state where the contact heating plate is fastened via the screw at the positions of the plurality of first through-holes.

As the printing apparatus according to a ninth aspect of the present disclosure, in the aspect depending on any one of the fourth to eighth aspects, the contact heating plate may include a second through-hole at both end portions in the width direction, and may be fastened via a screw to the heating plate holding portion at a position of the second through-hole such that the contact heating plate is fixed to the heating plate holding portion at a position of the second through-hole.

According to the present aspect, the contact heating plate includes the second through-hole at both end portions in the width direction, and the heating plate holding portion is fastened via the screw at the position of the second through-hole such that the contact heating plate is fixed to the heating plate holding portion at the position of the second through-hole. According to this configuration, even when the contact heating plate is expanded due to heating, the expansion amount of the contact heating plate can be released on both sides, based on the position of the second through-hole.

As the printing apparatus according to a tenth aspect of the present disclosure, in the aspect depending on the ninth aspect, the second through-hole may be provided at a center of the contact heating plate in the transport direction at each of both end portions of the contact heating plate in the width direction.

According to the present aspect, the second through-hole is provided at the center of the contact heating plate in the transport direction at each of both end portions of the contact heating plate in the width direction. According to this configuration, even when the contact heating plate is expanded due to heating, the expansion amount of the contact heating plate can be released on both sides, based on the center in the transport direction corresponding to the position of the second through-hole.

As the printing apparatus according to an eleventh aspect of the present disclosure, in the aspect depending on any aspect of the first to tenth aspects, in a state where the contact heating plate is held by the heating plate holding portion, the contact heating plate may be curved such that a center of the contact heating plate is convex toward a side opposite to a side held by the heating plate holding portion when viewed in the width direction.

According to the present aspect, in the state where the contact heating plate is held by the heating plate holding portion, the contact heating plate is curved such that the center is convex toward a side opposite to the side held by the heating plate holding portion when viewed in the width direction. According to this configuration, the transported medium can be effectively heated in the contact heating plate.

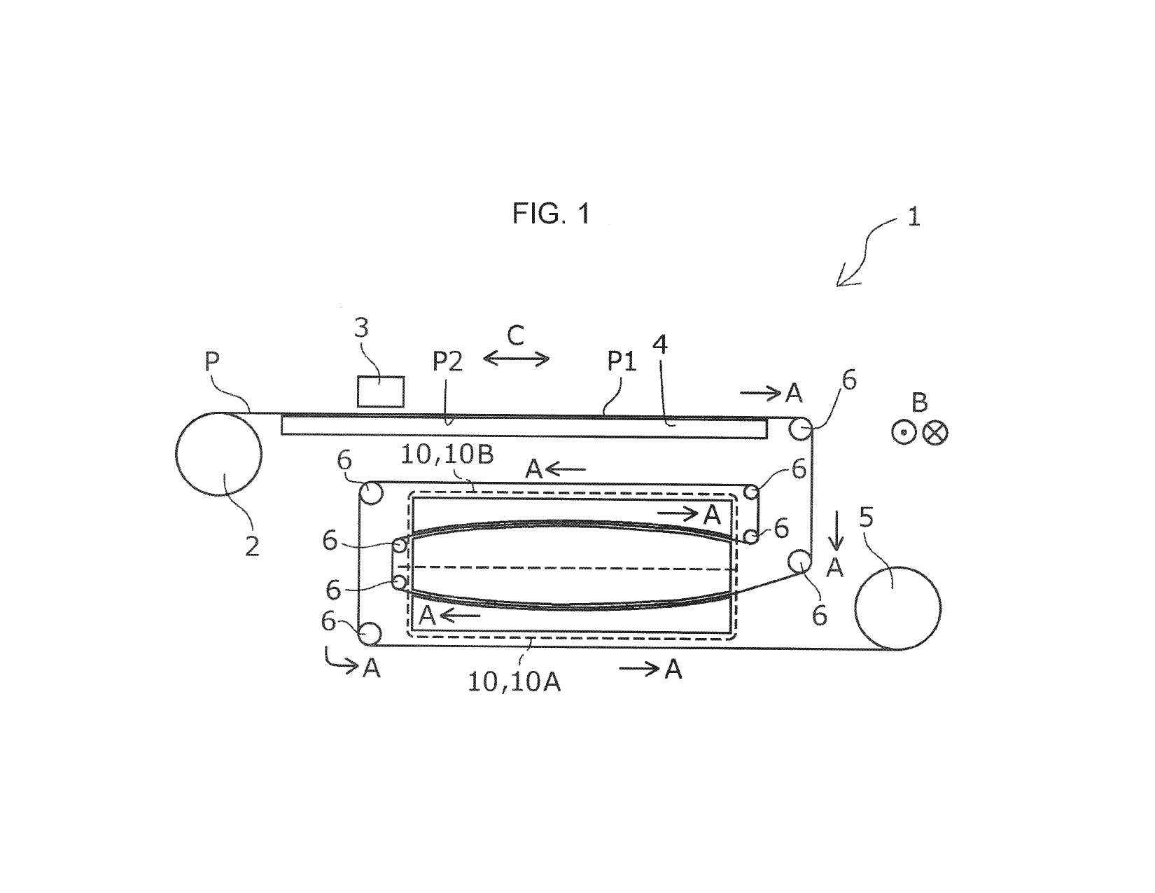

Hereinafter, embodiments according to the present disclosure will be described in detail with reference to the drawings. First, an outline of a printing apparatus 1 serving as an example of the present disclosure will be described with reference to FIG. 1. As illustrated in FIG. 1, the printing apparatus 1 of the present example includes a set section 2 that sets a roll-shaped medium P, a winding section 5 that winds the medium P transported from the set section 2, and a printing head 3 as a printing section that forms an image by discharging a liquid ink to a printing surface P1 of the medium P transported in a transport direction A in a transport path from the set section 2 to the winding section 5. In addition, the printing apparatus 1 includes a platen 4 that supports the medium P in an image formation region in which the image is formed by the printing head 3, and a plurality of rollers 6 provided in the transport path of the medium P. As the roller 6, the printing apparatus 1 of the present example includes a driving roller that applies a transport force to the medium P as a transport section, and a driven roller that is driven to rotate as the medium P is transported.

The printing head 3 is provided on a side facing the printing surface P1 of the medium P transported in the transport direction A, and discharges the ink to the printing surface P1 to form the image in a state where a back surface P2 of the medium P on a side opposite to the printing surface P1 of the medium P is supported by the platen 4. Specifically, the printing apparatus 1 of the present example prints the image by causing the printing head 3 to reciprocate in a scanning direction C along the transport direction A. More specifically, the printing apparatus 1 of the present example intermittently drives (intermittently transports) the medium P in the transport direction A, causes the printing head 3 to reciprocate in the scanning direction C, and discharges the ink from the printing head 3 to perform printing.

The printing head 3 of the present example can complete image formation over the entire image formation region supported by the platen 4 on the printing surface P1 in one scan (one pass), and can also complete image formation by performing a plurality of scans (plurality of passes) over the entire image formation region. Compared to when the image formation is completed in one pass, when the image formation is completed in the plurality of passes, a transport stop time of the medium P due to the intermittent transport is naturally increased.

The printing head 3 of the present example is configured to reciprocate in the scanning direction C along the transport direction A to perform the printing. However, the configuration of the printing head 3 is not particularly limited. Instead of the printing head 3 that reciprocates in the scanning direction C along the transport direction A to perform the printing, the printing head 3 that reciprocates in a width direction B intersecting the transport direction A to perform the printing may be provided. Alternatively, a so-called line head may be provided such that nozzles for discharging the ink over the entire width direction B of the medium P are aligned along the width direction B and the image is printed in a state where the printing head is stopped.

As illustrated in FIG. 1, a drying section 10 that dries the ink discharged to the medium P is provided downstream of the printing head 3 in the transport direction A in the transport path of the medium P. A plurality of rollers 6 are provided in the transport path of the medium P from the printing head 3 to the drying section 10 and the transport path of the medium P from the drying section 10 to the winding section 5. As the drying section 10, the printing apparatus 1 of the present example includes a first drying section 10A to which the medium P first reaches from the printing head 3, and a second drying section 10B that can further dry the medium P after the medium P is dried in the first drying section 10A. As illustrated in FIG. 1, in the present example, the first drying section 10A and the second drying section 10B are provided up and down. However, the present disclosure is not limited to this configuration.

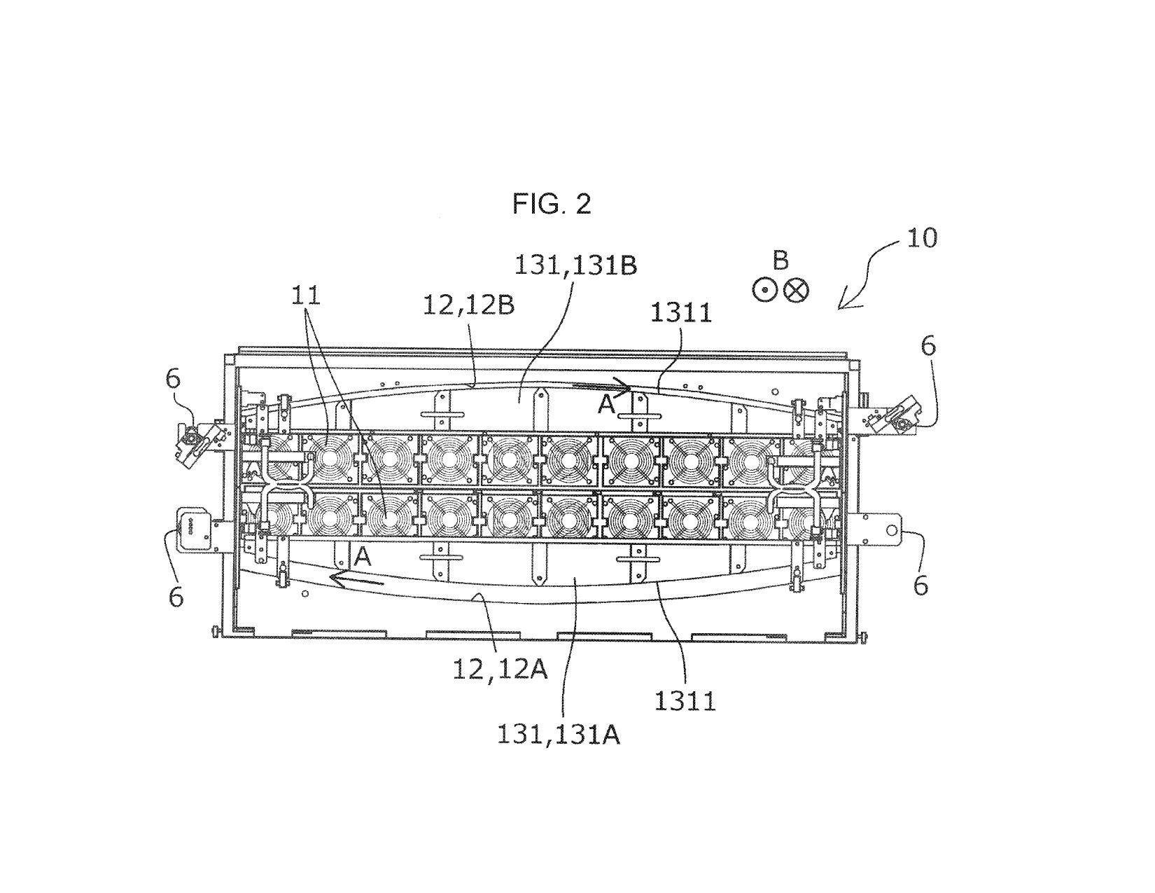

Hereinafter, the drying section 10 will be described in more detail with reference to FIGS. 2 to 12. As illustrated in FIG. 2, the drying section 10 includes a plurality of fans 11. As described above, the drying section 10 is divided into the first drying section 10A and the second drying section 10B. In the first drying section 10A, an air flow generated by the fan 11 can be ejected from a first air flow ejecting portion 12A on a lower surface side toward the printing surface P1 of the medium P. In the second drying section 10B, the air flow generated by the fan 11 can be ejected from a second air flow ejecting portion 12B on an upper surface side toward the printing surface P1 of the medium P. The first air flow ejecting portion 12A and the second air flow ejecting portion 12B have the same configuration.

As illustrated in FIG. 2, the first drying section 10A includes a first contact heating portion 131A as a contact heating portion 131 in a region facing the first air flow ejecting portion 12A in the transport path of the medium P. The first contact heating portion 131A includes a contact heating plate 1311 that comes into contact with and heats the back surface P2 of the medium P. On the other hand, the second drying section 10B includes a second contact heating portion 131B as the contact heating portion 131 in a region facing the second air flow ejecting portion 12B in the transport path of the medium P. The second contact heating portion 131B includes a contact heating plate 1311 that comes into contact with and heats the back surface P2 of the medium P. The first contact heating portion 131A and the second contact heating portion 131B have the same configuration. For example, the contact heating plate 1311 can be configured to include a rubber heater 1312 as in the present example (to be described later).

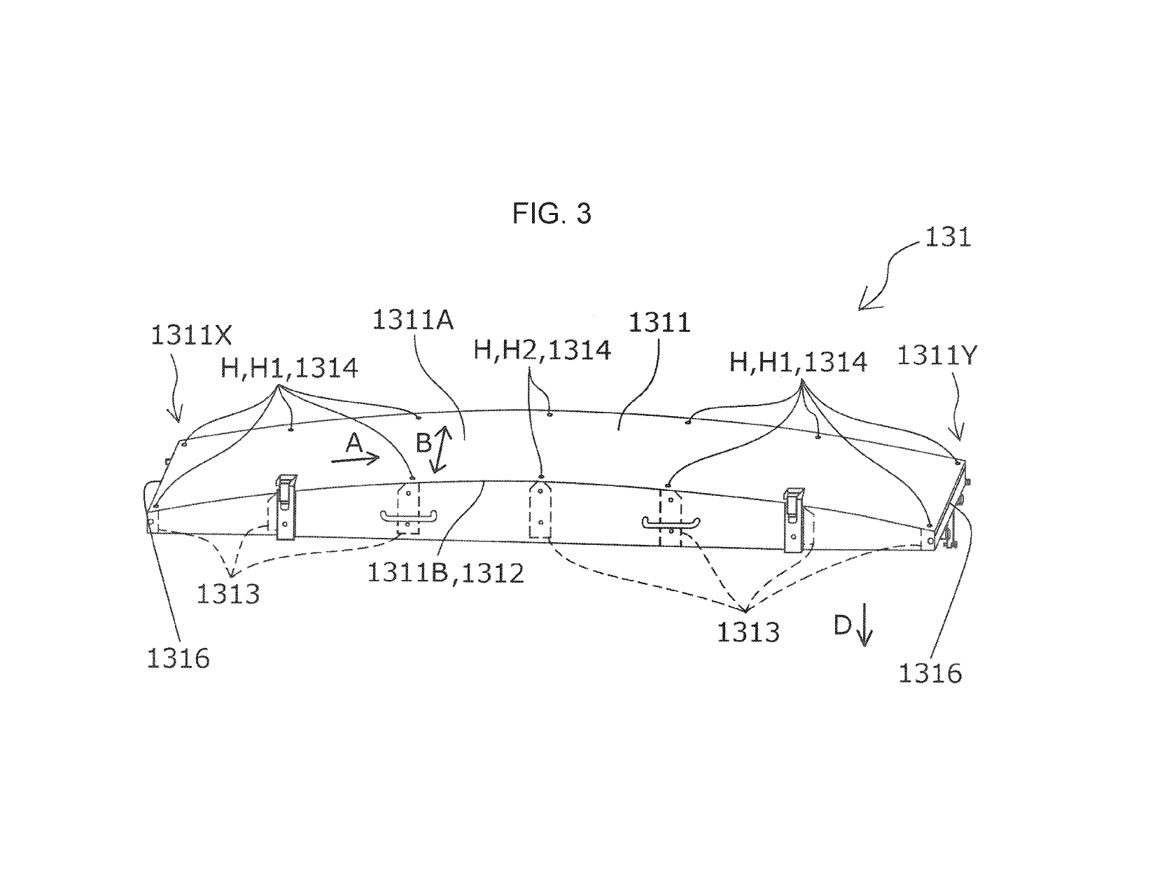

In this way, the printing apparatus 1 of the present example includes the roller 6 as the transport section that transports the medium P in the transport direction A, the printing head 3 as the printing section that discharges the liquid to the medium P transported by the roller 6 to perform the printing, and the drying section 10 that dries the medium P after the printing is performed by the printing head 3. Hereinafter, details of the contact heating portion 131 in the second drying section 10B, which is the drying section 10, which is a main section of the printing apparatus 1 of the present example, will be described with reference to FIGS. 3 to 13. Since the first drying section 10A and the second drying section 10B have the same configuration, description of the contact heating portion 131 of the first drying section 10A will be omitted.

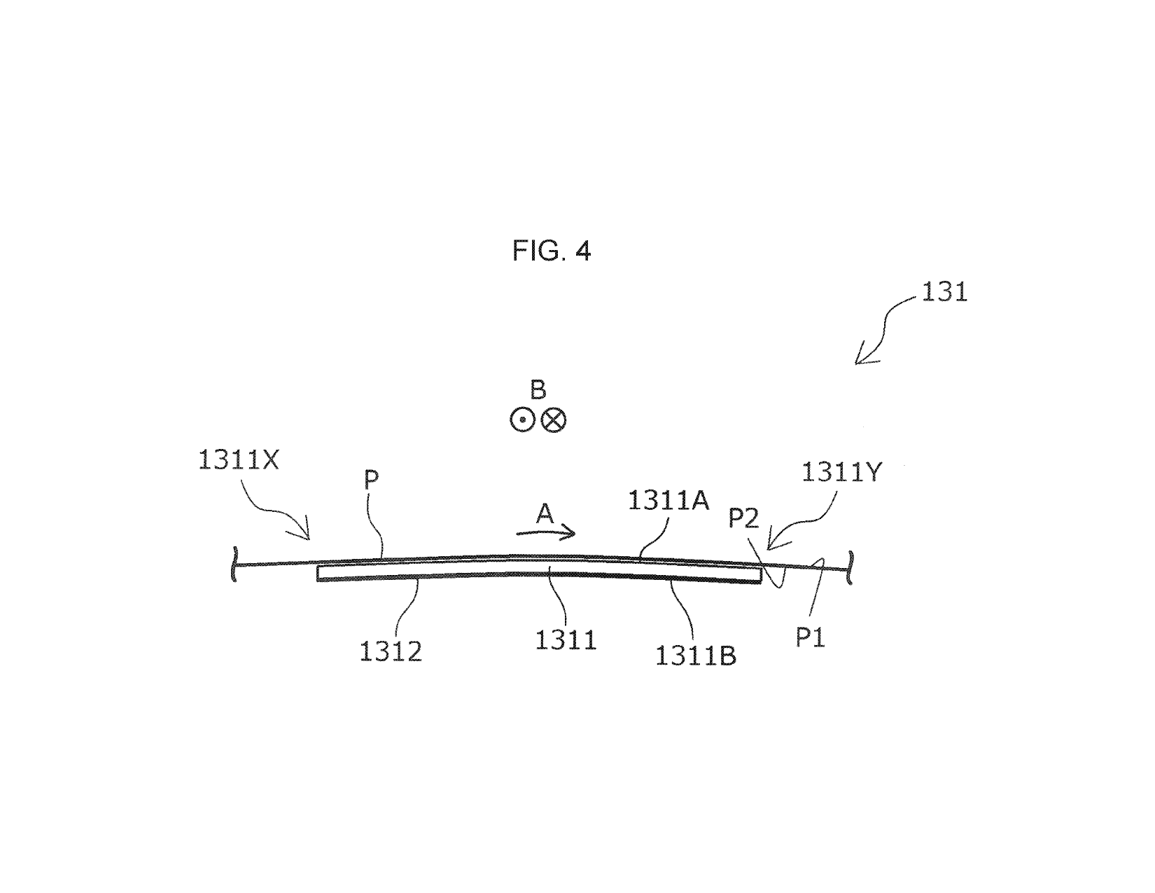

As illustrated in FIGS. 3 to 13, the contact heating portion 131 of the drying section 10 includes the contact heating plate 1311 that comes into contact with the back surface P2, which is a surface opposite to the printing surface P1 of the medium P after the printing, on a first surface 1311A. As illustrated in FIGS. 3 and 4, the contact heating portion 131 includes a rubber heater 1312 as a heating portion that heats the contact heating plate 1311 by being attached to a second surface 1311B, which is a side opposite to the first surface 1311A, from the second surface 1311B side, and a heating plate holding portion 1313 to which the contact heating plate 1311 is attached.

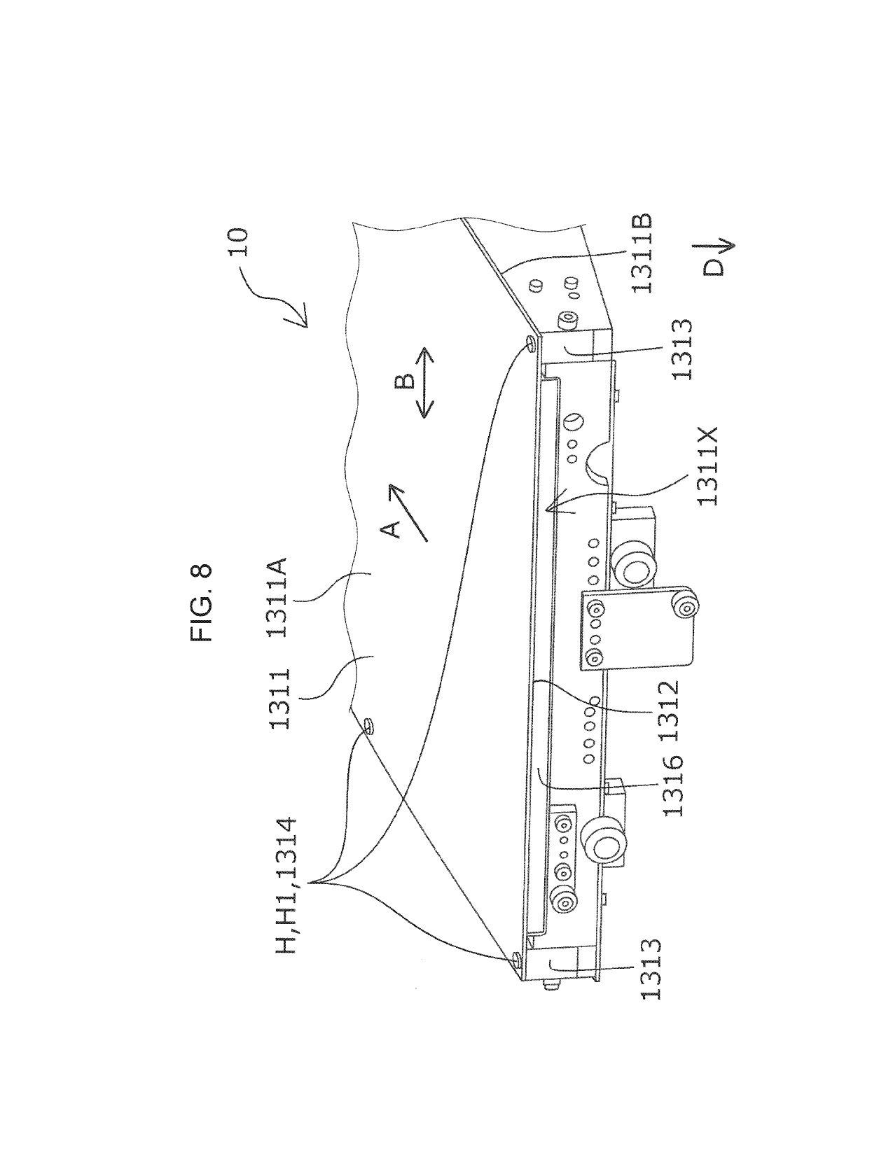

In addition, as illustrated in FIGS. 8 to 10, in the contact heating portion 131, a reinforcing member 1316 extending in the width direction B intersecting the transport direction A is fixed to each of an upstream end portion 1311X and a downstream end portion 1311Y in the transport direction A, on the second surface 1311B of the contact heating plate 1311.

According to this configuration, a possibility that the contact heating plate 1311 is deformed into a shape which is convex to a side of the first surface 1311A when viewed in the transport direction A can be suppressed. Therefore, the printing apparatus 1 of the present example can suppress an increase in a transport load when the contact heating plate 1311 is deformed into a shape in which the contact heating plate 1311 is convex toward the side of the first surface 1311A due to influence of heat during a manufacturing process or drying in the drying section.

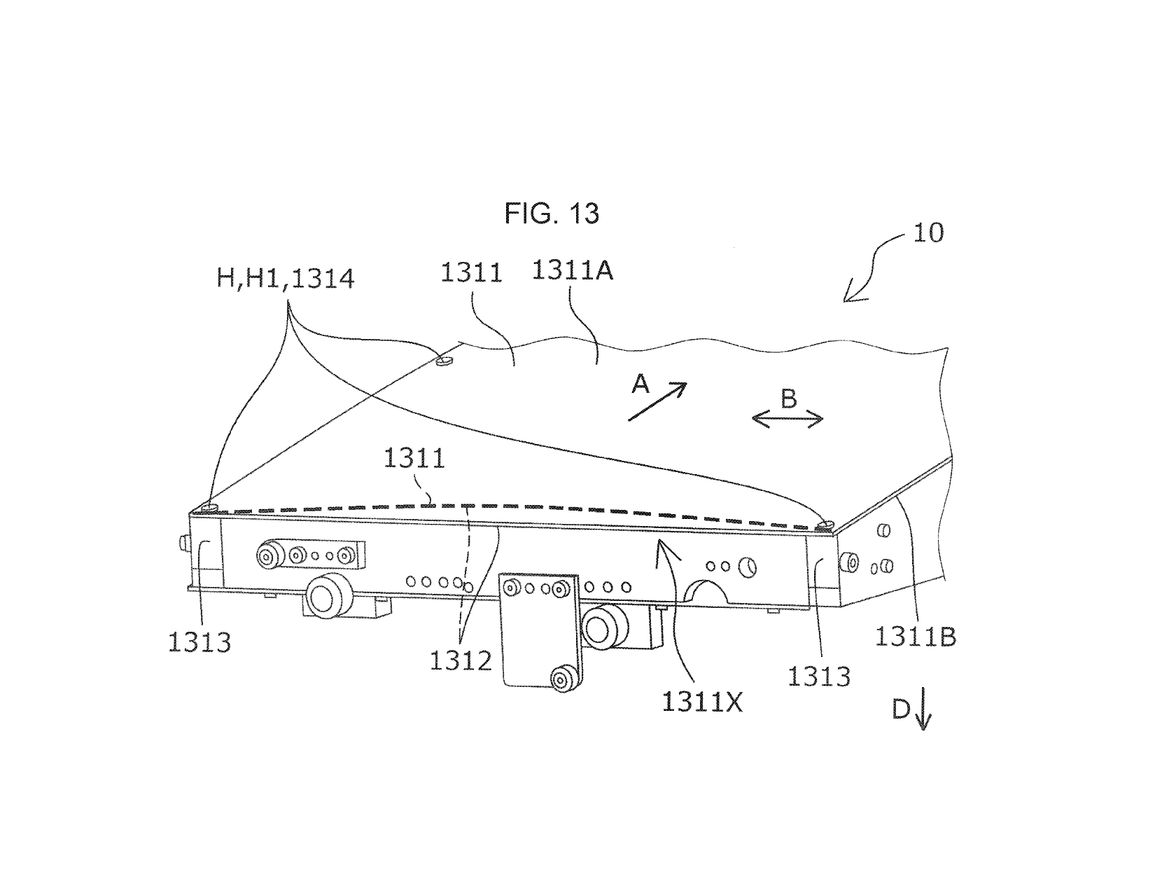

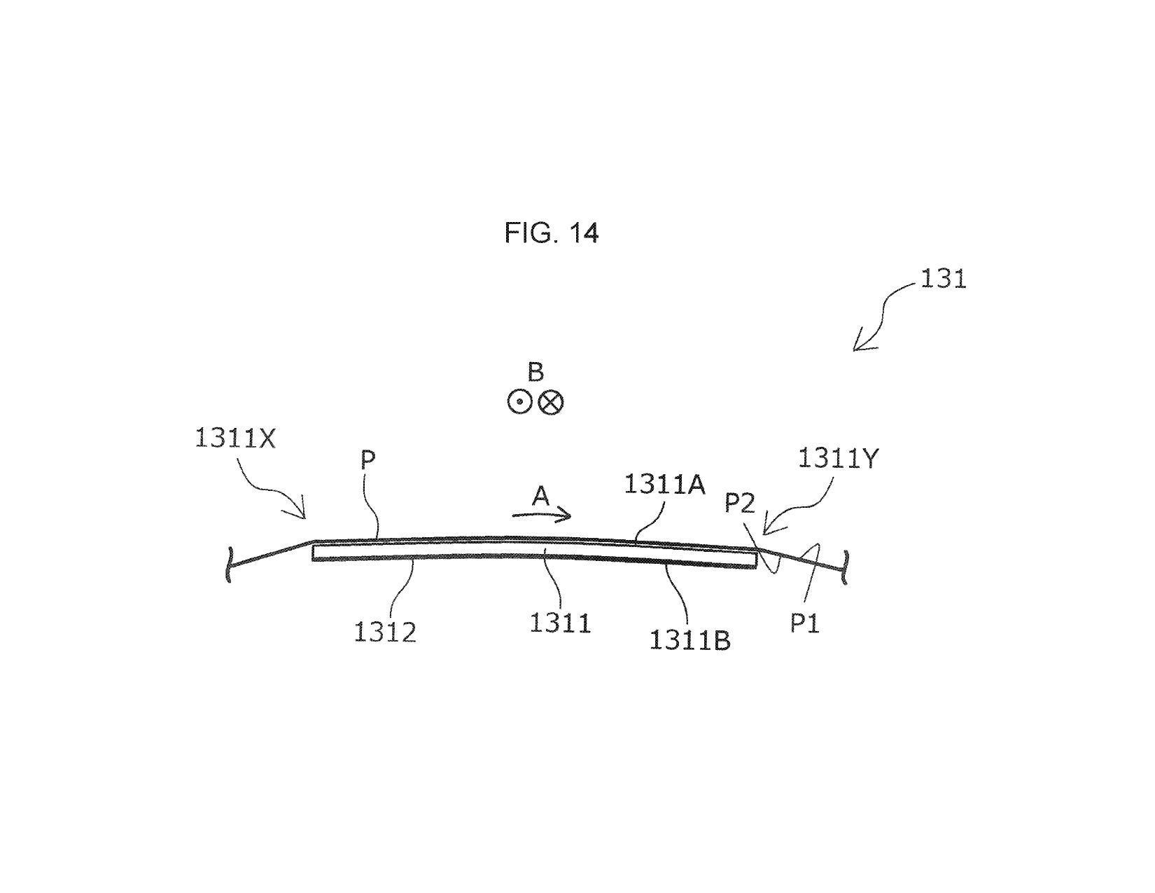

The above-described configuration will be described in more detail. In a printing apparatus of a reference example having a configuration in which the contact heating plate 1311 as illustrated in FIG. 13 does not include the reinforcing member 1316, the contact heating plate 1311 may be deformed in the upstream end portion 1311X and the downstream end portion 1311Y of the contact heating plate 1311 as illustrated by a broken line in FIG. 13. In this case, as illustrated in FIG. 14, the contact heating plate 1311 forms a crease in the upstream end portion 1311X and the downstream end portion 1311Y with respect to the transported medium P, and a frictional force becomes strong in the upstream end portion 1311X and the downstream end portion 1311Y of the contact heating plate 1311 with respect to the transported medium P.

When the frictional force becomes strong in the upstream end portion 1311X and the downstream end portion 1311Y of the contact heating plate 1311 with respect to the transported medium P, the transport load may increase, and transport accuracy may be lowered. In particular, as illustrated by the broken line in FIG. 13, when the contact heating plate 1311 is curved so that a center is convex toward a side opposite to a side held by the heating plate holding portion 1313 when viewed in the transport direction A, there is a tendency that the frictional force becomes strong in the upstream end portion 1311X and the downstream end portion 1311Y of the contact heating plate 1311.

On the other hand, in the printing apparatus 1 of the present example, the contact heating plate 131 is not deformed in the upstream end portion 1311X and the downstream end portion 1311Y of the contact heating plate 1311. Therefore, as illustrated in FIG. 4, the contact heating plate 1311 does not form the crease in the upstream end portion 1311X and the downstream end portion 1311Y with respect to the transported medium P. Therefore, the frictional force does not become strong in the upstream end portion 1311X and the downstream end portion 1311Y of the contact heating plate 1311 with respect to the transported medium P, and the transport load does not increase, and the transport accuracy is not lowered.

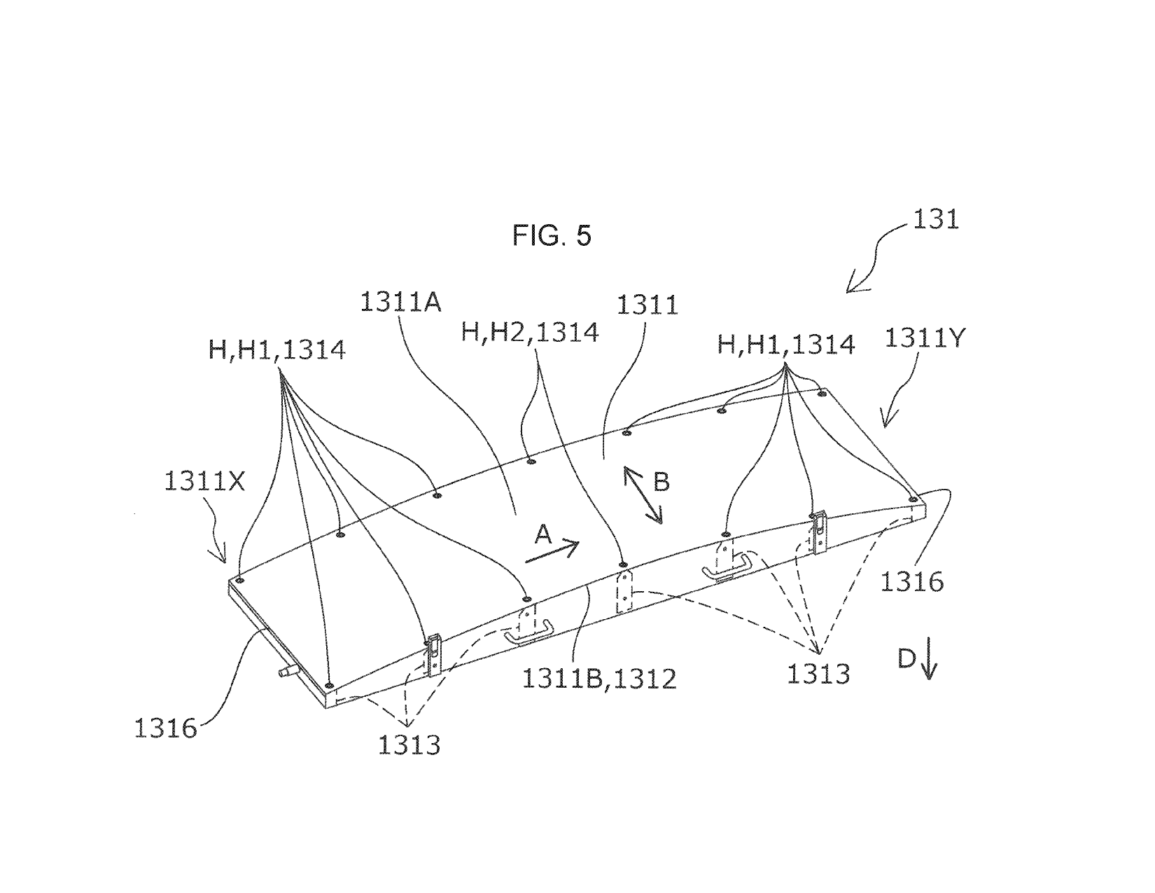

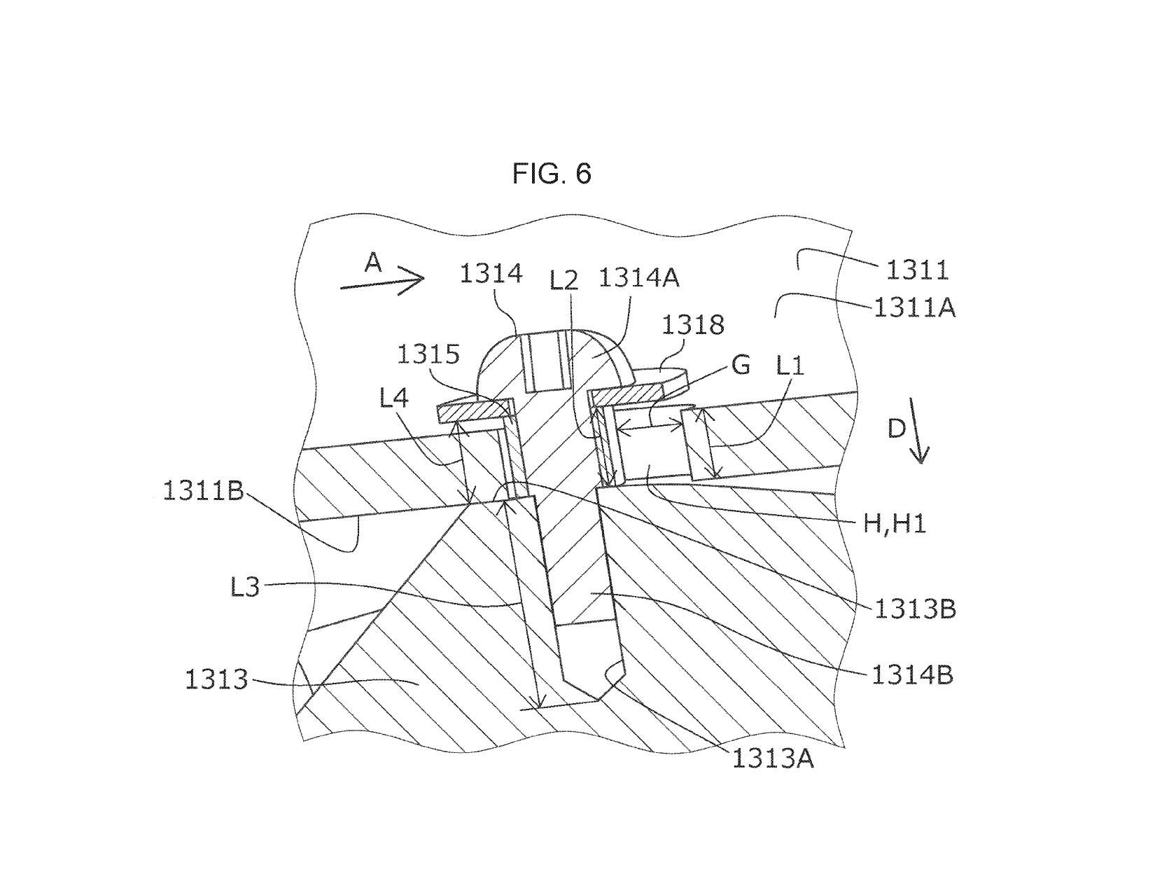

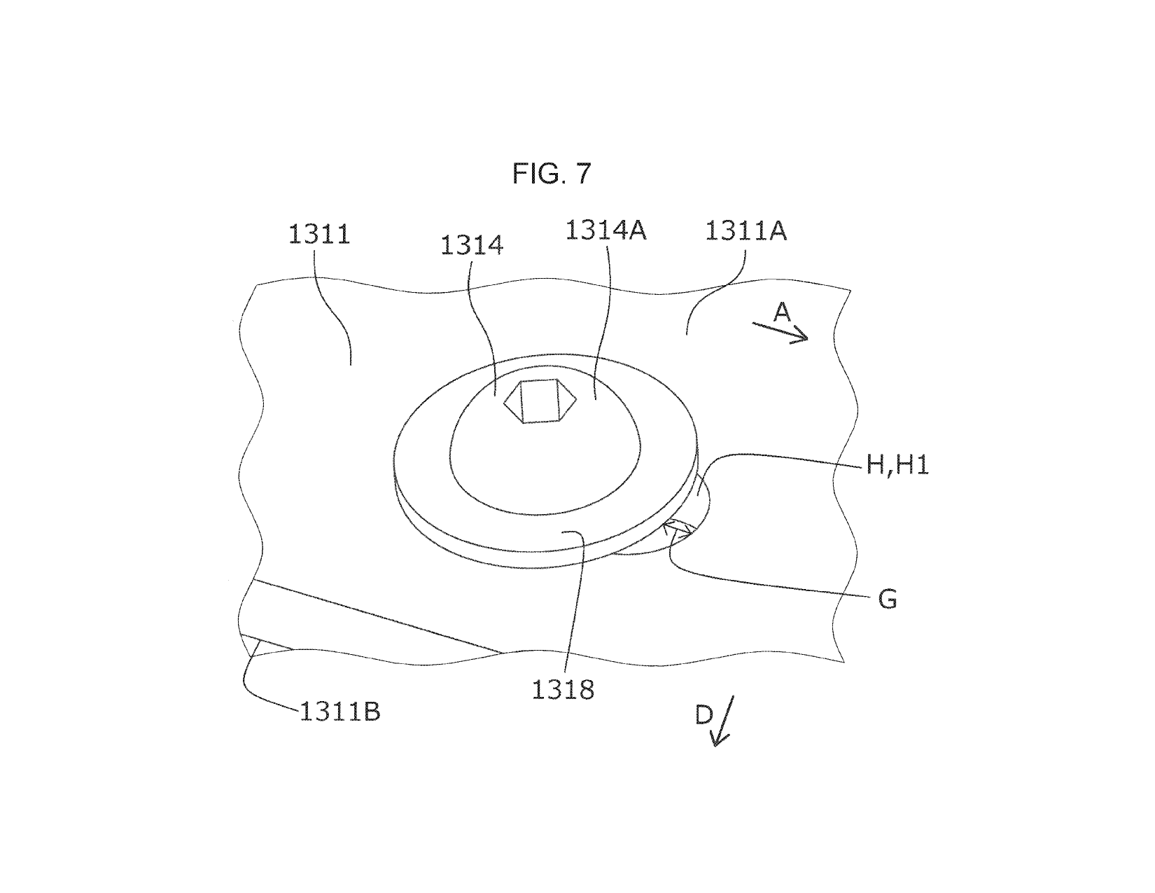

In addition, in the printing apparatus 1 of the present example, as illustrated in FIG. 5 and the like, a plurality of first through-holes H1 and second through-holes H2 as through-holes H are aligned along the transport direction A at both end portions of the contact heating plate 1311 in the width direction B, and the contact heating plate 1311 is fastened via a screw 1314 to the heating plate holding portion 1313 at positions of the plurality of first through-holes H1 and second through-holes H2. Here, in a state where the contact heating plate 1311 is fastened via the screw at the positions of the plurality of first through-holes H1 and second through-holes H2, the contact heating plate 1311 is movable with respect to the heating plate holding portion 1313 in the thickness direction D (refer to FIGS. 6 and 7) which is a direction corresponding to the thickness direction intersecting a surface direction of the contact heating plate 1311 and a direction intersecting the thickness direction D (surface directions of the first surface 1311A and the second surface 1311B).

In the printing apparatus 1 of the present example, according to this configuration, even when the contact heating plate 1311 is expanded due to heating, an expansion amount of the contact heating plate 1311 can be released in the thickness direction D and the direction intersecting the thickness direction D, and the expansion of the contact heating plate 1311 in the thickness direction of the screw can be suppressed. Therefore, the printing apparatus 1 of the present example can effectively suppress an increase in the transport load when the contact heating plate 1311 is deformed due to heat.

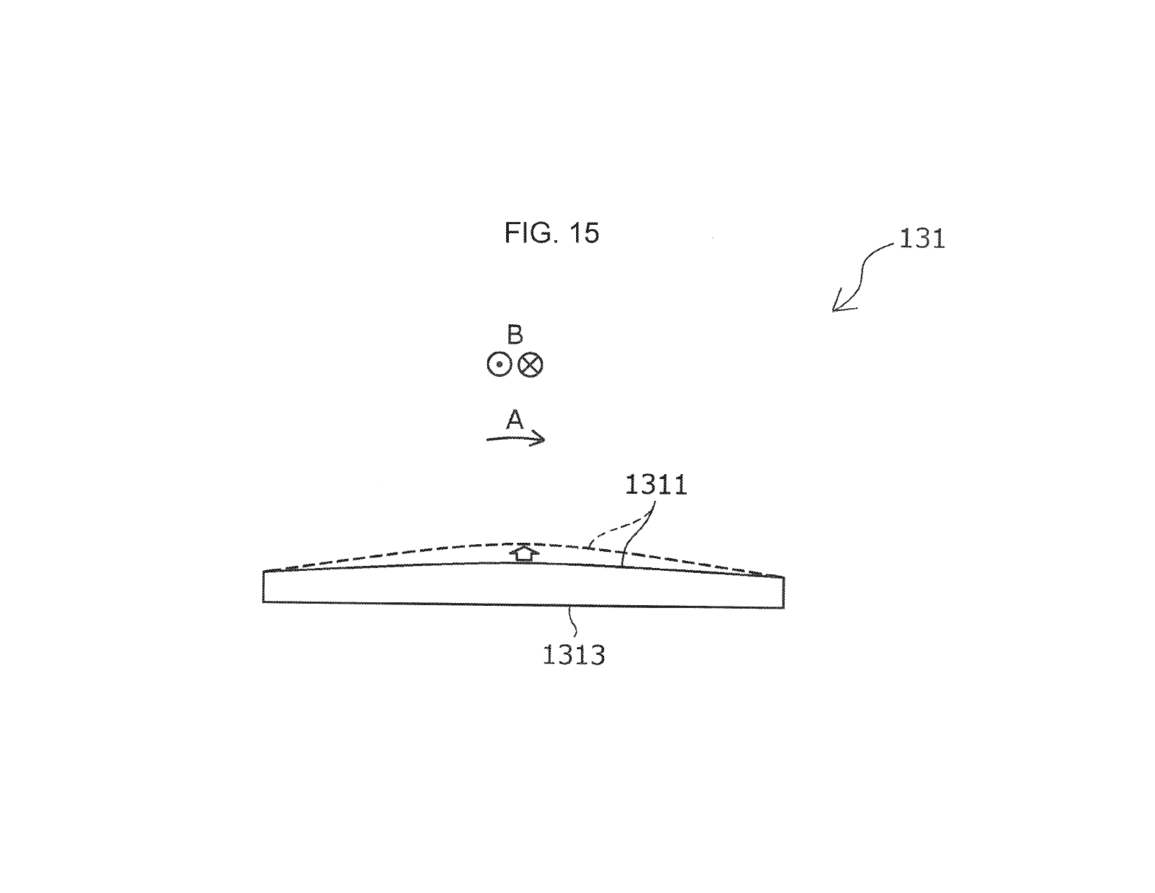

The above-described configuration will be described in more detail. In the printing apparatus of the reference example illustrated in FIG. 13, the contact heating plate 1311 is fixed to the heating plate holding portion 1313, and is not configured to be movable with respect to the heating plate holding portion 1313. In this case, as illustrated in FIG. 15, the contact heating plate 1311 is deformed from a state illustrated by a solid line to a state illustrated by a broken line, and the frictional force becomes strong even in a case of this deformation. When the frictional force of the contact heating plate 1311 with respect to the transported medium P becomes strong, the transport load may increase, and the transport accuracy may be lowered. On the other hand, the printing apparatus 1 of the present example can suppress the deformation of the contact heating plate 1311 as illustrated in FIG. 15. Therefore, the transport load does not increase, and the transport accuracy is not lowered.

In the state illustrated by the broken line in FIG. 15, the entire contact heating plate 1311 is illustrated as being largely curved such that the center is convex toward the side opposite to the side held by the heating plate holding portion 1313 when viewed in the width direction B. However, this is a conceptual representation. In fact, a portion corresponding to a distance between portions fastened via the screw 1314 is curved to be convex by approximately 1 mm to 2 mm toward the side opposite to the side held by the heating plate holding portion 1313. This phenomenon is likely to appear immediately after a temperature of the contact heating plate 1311 rises, and in some cases, this phenomenon may be improved by the expansion of the heating plate holding portion 1313 or the like after the temperature rises for a while.

Here, as illustrated in FIGS. 6 and 7, the drying section 10 of the printing apparatus 1 of the present example includes a spacer 1315 fitted to the first through-hole H1 in a lower portion of a screw head 1314A of the screw 1314. Specifically, as illustrated in FIG. 6, the drying section 10 includes the spacer 1315 having a thickness L2 larger than a depth L1 of the first through-hole H1.

According to this configuration, in the printing apparatus 1 of the present example, even when the contact heating plate 1311 is expanded due to the heating, the expansion amount of the contact heating plate 1311 can be particularly effectively released in the thickness direction D and the direction intersecting the thickness direction D (surface directions of the first surface 1311A and the second surface 1311B), and the expansion of the contact heating plate 1311 in the thickness direction D and the direction intersecting the thickness direction D can be particularly effectively suppressed. Therefore, the printing apparatus 1 of the present example can particularly effectively suppress the increase in the transport load when the contact heating plate 1311 is deformed due to the heat.

In the present example, the spacer 1315 having a separate configuration from the screw 1314 is provided. However, a configuration such as a stepped screw may be adopted in which the screw 1314 and the spacer 1315 are integrally configured. In this case, a stepped portion of the stepped screw functions as the spacer 1315. In addition, in the present example, as illustrated in FIGS. 6 and 7, a washer 1318 is provided between the screw head 1314A and the first surface 1311A. However, the washer 1318 may not be provided as long as the screw head 1314A has a size that does not fit to the first through-hole H1. When the washer 1318 is provided, the screw head 1314A can be regarded as including the washer 1318.

Instead of providing this spacer 1315, a depth L3 of the screw hole 1313A fitted to the screw of the heating plate holding portion 1313 may be a depth at which a distance L4 between the screw head 1314A of the screw 1314 and a forming surface 1313B of the screw hole 1313A when the heating plate holding portion 1313 is fastened via the screw at the position of the first through-hole H1 is larger than the depth L1 of the first through-hole H1, which is the thickness of the contact heating plate 1311. According to this configuration as well, even when the contact heating plate 1311 is expanded due to the heating, the expansion amount of the contact heating plate 1311 can be particularly effectively released in the thickness direction D and the direction intersecting the thickness direction D, and the expansion of the contact heating plate 1311 in the thickness direction D and the direction intersecting the thickness direction D can be particularly effectively suppressed.

Here, as illustrated in FIGS. 6 and 7, the first through-hole H1 is an elongated hole long in one direction (transport direction A) when viewed from the first surface 1311A. In other words, as illustrated in FIG. 6, the first through-hole H1 has a width having a distance G from the screw shaft 1314B of the screw 1314 in the surface directions of the first surface 1311A and the second surface 1311B. According to this configuration, a configuration can be easily formed in which the contact heating plate 1311 is movable with respect to the heating plate holding portion 1313 in the direction intersecting the thickness direction D in a state where the contact heating plate 1311 is fastened via the screw at the position of the plurality of first through-holes H1. A fact that the first through-hole H1 has the width having the distance G from the screw shaft 1314B of the screw 1314 means that the screw shaft is regarded as also including the spacer 1315, and the first through-hole H1 has the width having the distance from the spacer 1315, when the first through-hole H1 includes the spacer 1315 as in the present example.

In addition, in the printing apparatus 1 of the present example, as illustrated in FIG. 5, the contact heating plate 1311 includes the second through-hole H2 at both end portions in the width direction B. In the printing apparatus 1 of the present example, the contact heating plate 1311 is fixed to the heating plate holding portion 1313 to be immovable in the thickness direction D and the direction intersecting the thickness direction D at the position of the second through-hole H2 by being fastened via the screw to the heating plate holding portion 1313 at the position of the second through-hole H2. In the printing apparatus of the present example, according to this configuration, even when the contact heating plate 1311 is expanded due to the heating, the expansion amount of the contact heating plate 1311 can be released on both sides (both sides along the transport direction A), based on the position of the second through-hole H2.

Specifically, as illustrated in FIG. 5, the second through-hole H2 is provided at the center of the contact heating plate 1311 in the transport direction A at each of both end portions of the contact heating plate 1311 in the width direction B. According to this configuration, even when the contact heating plate 1311 is expanded due to the heating, the expansion amount of the contact heating plate 1311 can be released on both sides, based on the center in the transport direction A which corresponds to the position of the second through-hole H2. The "center" here does not require the center in a strict sense, and means that the center may be approximately determined.

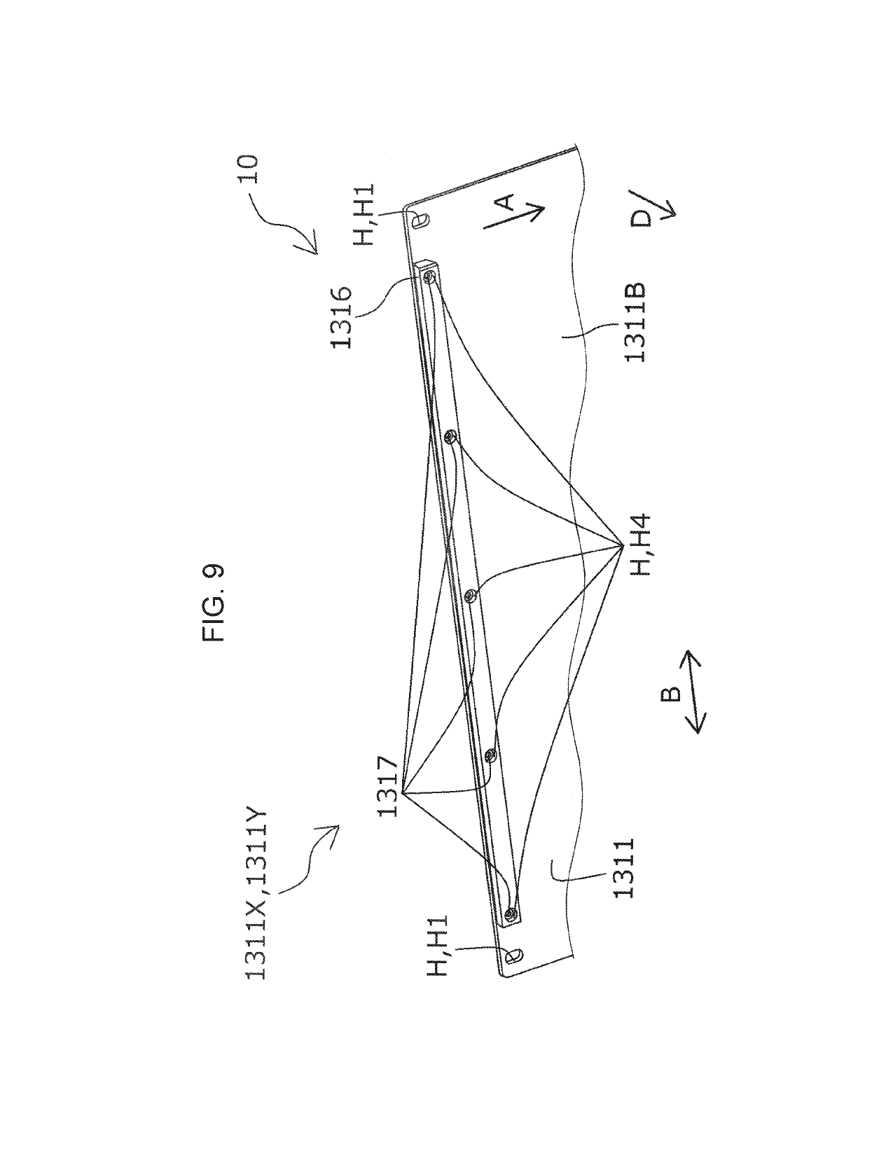

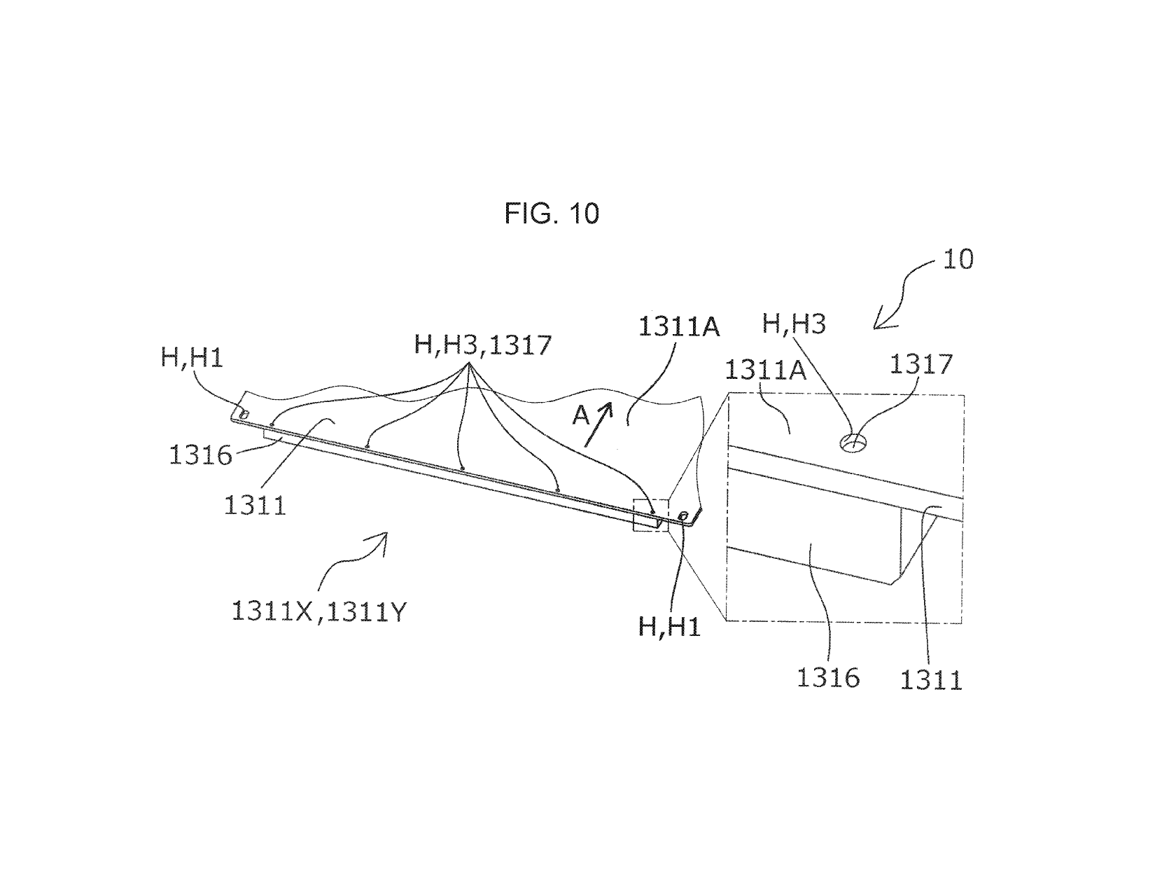

Here, the reinforcing member 1316 will be described in more detail. In the printing apparatus 1 of the present example, as illustrated in FIG. 10, a screw hole H3 as the through-hole H is provided in the contact heating plate 1311, and as illustrated in FIG. 9, a screw hole H4 as the through-hole H is provided in the reinforcing member 1316. The reinforcing member 1316 is fixed to the contact heating plate 1311 by fitting the screw 1317 into the screw hole H3 via the screw hole H4 from the side of the second surface 1311B of the contact heating plate 1311.

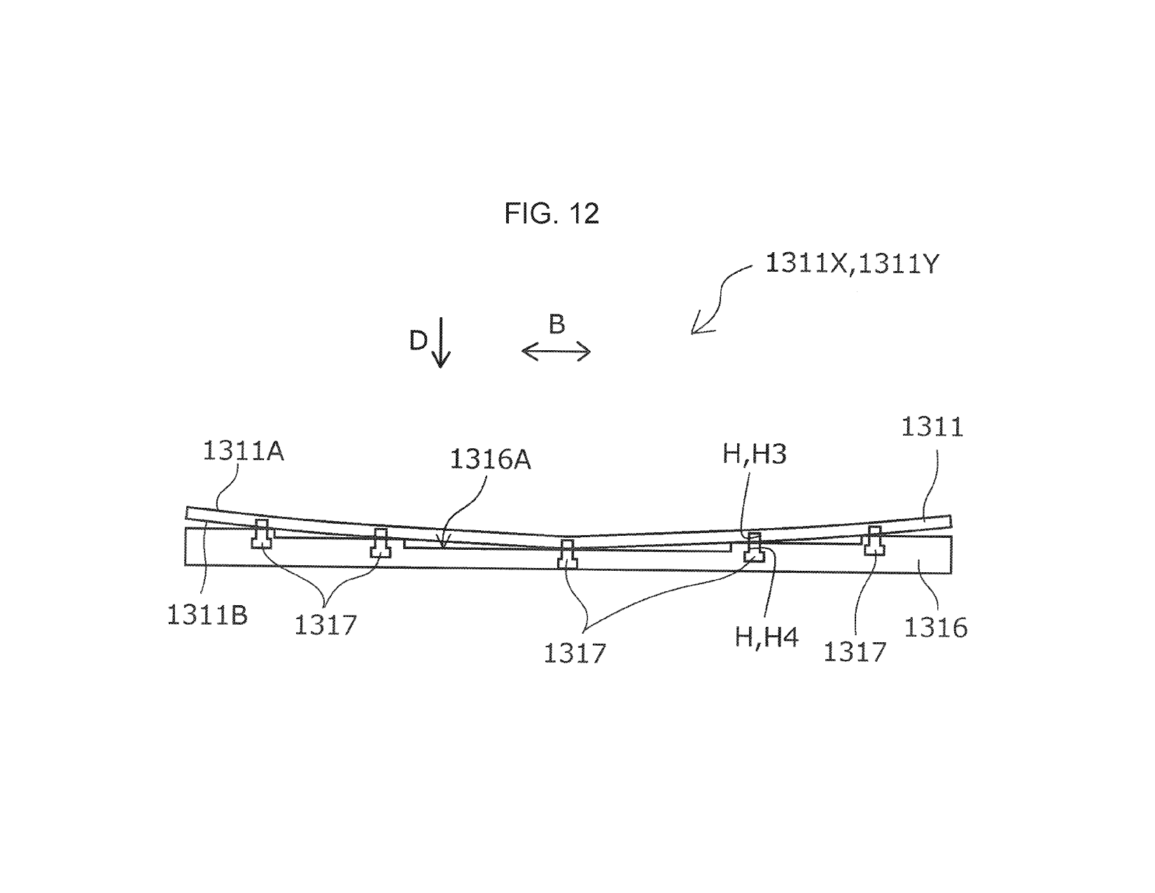

In this case, as illustrated in FIG. 12, a shaft of the screw 1317 that fixes the reinforcing member 1316 and the contact heating plate 1311 does not protrude to the first surface 1311A. That is, the reinforcing member 1316 is fixed only to the second surface 1311B of the contact heating plate 1311, including a fixing member (screw 1317) of the reinforcing member 1316, and does not protrude to the first surface 1311A. In this way, a configuration is adopted such that the reinforcing member 1316 is not fixed except of the second surface 1311B. Accordingly, a possibility or the like that the reinforcing member 1316, a fixing portion thereof, or the like protrude to the first surface 1311A and comes into contact with the transported medium P can be suppressed. In addition, a force applied to the reinforcing member 1316 via the contact heating plate 1311 can be prevented from directly affecting members other than the reinforcing member 1316.

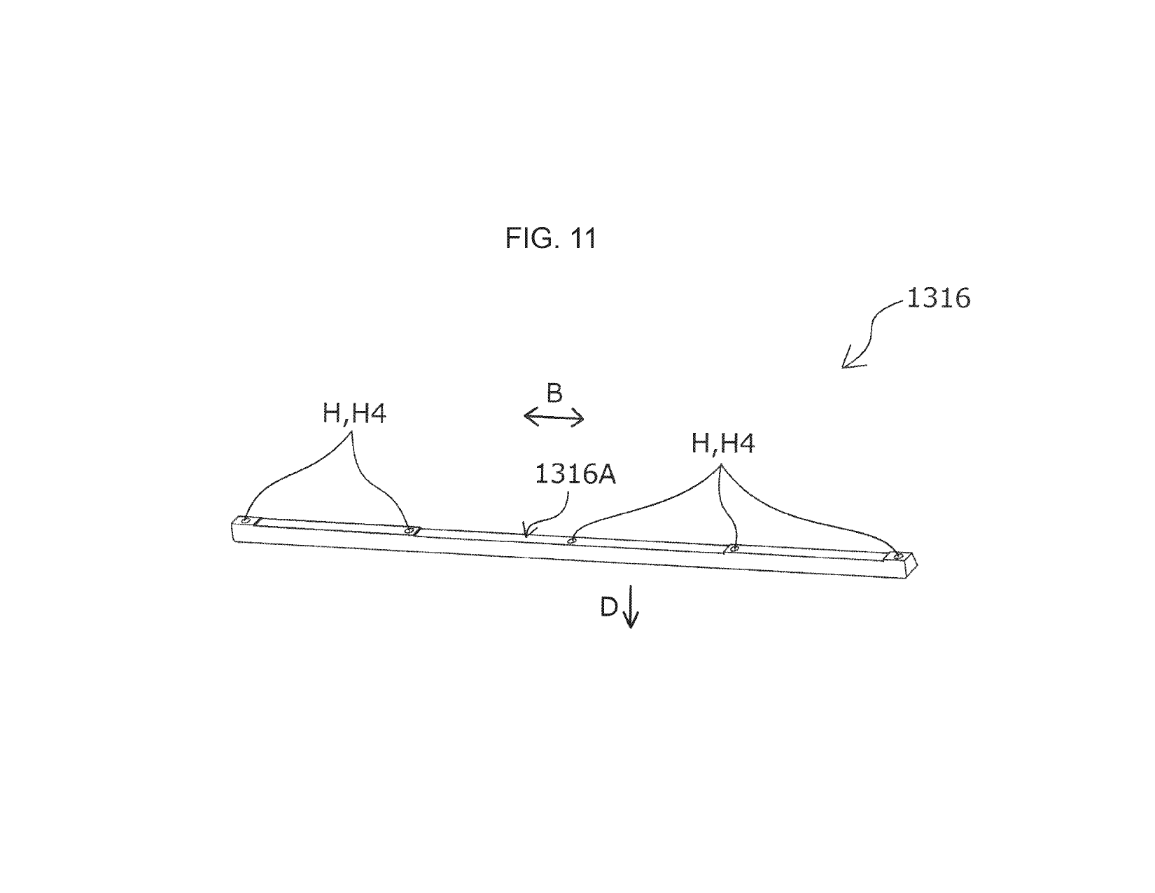

In addition, as illustrated in FIGS. 11 and 12, the reinforcing member 1316 includes a concave surface 1316A in which the thickness gradually decreases from the outside toward the center side in the width direction B, in the thickness direction D corresponding to the thickness direction intersecting the surface direction of the contact heating plate 1311. A step difference of the concave surface 1316A can be set to 0.25 mm or the like, for example. As illustrated in FIG. 12, the contact heating plate 1311 is fixed via the screw 1317 along the concave surface 1316A. That is, a surface of the reinforcing member 1316 on a side attached to the contact heating plate 1311 is the concave surface. According to this configuration, in a state where the reinforcing member 1316 is fixed to the contact heating plate 1311, the contact heating plate 1311 is curved such that the center is concave toward a side to which the contact heating plate 1311 is fixed when viewed in the transport direction A. Therefore, a possibility that the contact heating plate 1311 is curved such that the center is convex toward a side opposite to the side held by the heating plate holding portion 1313 when viewed in the transport direction A can be suppressed. Friction between the transported medium P and the first surface 1311A can be reduced, and an increase in the transport load can be effectively suppressed.

As illustrated in FIGS. 3 and 5, in a state where the contact heating plate 1311 is held by the heating plate holding portion 1313, the contact heating plate 1311 is curved such that the center is convex toward the side opposite to the side held by the heating plate holding portion 1313 when viewed in the width direction B. According to this configuration, the transported medium P can be effectively heated in the contact heating plate 1311.

The present disclosure is not limited to the above-described examples, and can be realized in various configurations without departing from the gist of the present disclosure. For example, technical features in the examples corresponding to technical features in each form described in a column of the outline of the disclosure can be appropriately replaced or combined to partially or entirely solve the above-described problems, or to partially or entirely achieve the above-described advantageous effects. In addition, when the technical features are not described herein as essential elements, the technical features can be appropriately deleted.

What is claimed is:

1. A printing apparatus comprising:
a transport section that transports a medium in a transport direction;
a printing section that performs printing by discharging a liquid to the medium transported by the transport section; and
a drying section that dries the medium after the printing is performed by the printing section, wherein
the drying section includes a contact heating plate that comes into contact with a back surface of the medium, which is a surface opposite to a printing surface of the medium after the printing, on a first surface, a heating portion that heats the contact heating plate, and a heating plate holding portion to which the contact heating plate is attached, and
a reinforcing member extending in a width direction intersecting the transport direction is fixed to each of an upstream end portion and a downstream end portion in the transport direction, on a second surface of the contact heating plate on a side opposite to the first surface.

2. The printing apparatus according to claim 1, wherein
the reinforcing member is fixed only to the second surface without coming into contact with the heating plate holding portion.

3. The printing apparatus according to claim 1, wherein
a surface of the reinforcing member on a side attached to the contact heating plate is a concave surface.

4. The printing apparatus according to claim 1, wherein
the contact heating plate is provided with a plurality of first through-holes aligned along the transport direction at both end portions in the width direction, is fastened via a screw to the heating plate holding portion at positions of the plurality of first through-holes, and is movable with respect to the heating plate holding portion in a direction intersecting a thickness direction of the contact heating plate in a state where the contact heating plate is fastened via the screw at the positions of the plurality of first through-holes.

5. The printing apparatus according to claim 4, wherein
the drying section includes a spacer thicker than a depth of the first through-hole, the space being provided between a forming surface of a screw hole fitted to the screw of the heating plate holding portion and a screw head of the screw.

6. The printing apparatus according to claim 4, wherein
the screw is a stepped screw having a stepped portion, and a thickness of the stepped portion is thicker than a depth of the first through-hole.

7. The printing apparatus according to claim 4, wherein
a depth of a screw hole fitted to the screw of the heating plate holding portion is a depth at which a distance between a screw head of the screw and a forming surface of the screw hole is larger than a thickness of the contact heating plate when the contact heating plate is fastened via the screw at the position of the first through-hole.

8. The printing apparatus according to claim 4, wherein
the first through-hole has a width having a distance from a screw shaft of the screw.

9. The printing apparatus according to claim 4, wherein
the contact heating plate includes a second through-hole at both end portions in the width direction, and is fastened via a screw to the heating plate holding portion at a position of the second through-hole such that the contact heating plate is fixed to the heating plate holding portion at a position of the second through-hole.

10. The printing apparatus according to claim 9, wherein
the second through-hole is provided at a center of the contact heating plate in the transport direction at each of both end portions of the contact heating plate in the width direction.

11. The printing apparatus according to claim 1, wherein
in a state where the contact heating plate is held by the heating plate holding portion, the contact heating plate is curved such that a center of the contact heating plate is convex toward a side opposite to a side held by the heating plate holding portion when viewed in the width direction.
